(19) United States
(12) Patent Application Publication
(10) Pub. No.: US 2025/0350668 A1
(43) Pub. Date: Nov. 13, 2025

(54) METHODS AND APPARATUS FOR A FIFTH GENERATION (5G) ROAMING SOLUTION USING PROTOCOL FOR N32 INTERCONNECT SECURITY (PRINS) WITH ROAMING INTERMEDIARIES

(71) Applicant: CABLE TELEVISION LABORATORIES, INC., Louisville, CO (US)

(72) Inventor: Tao Wan, Ottawa (CA)

(21) Appl. No.: 19/198,714

(22) Filed: May 5, 2025

Related U.S. Application Data
(60) Provisional application No. 63/644,961, filed on May 9, 2024.

(51) Int. Cl. H04L 67/563; H04L 67/02; H04L 67/567

(52) U.S. Cl. CPC H04L 67/563; H04L 67/02; H04L 67/567

(57) ABSTRACT

Methods and apparatus for session management for a Fifth Generation (5G) roaming solution using PRotocol for N32 INterconnect Security (PRINS) are provided herein. A first roaming intermediary (RI) Proxy receives a first hypertext transfer protocol secure (HTTPS) request, including a first JavaScript Object Notation (JSON) Web Encryption (JWE) token. The first RI Proxy reconstructs a first hypertext transfer protocol (HTTP) request based on the JWE token, and forwards the first HTTP request to a first RI application. The first RI Proxy receives a second HTTP request from the first RI application. The first RI Proxy creates a first JSON patch based on the first HTTP request and the second HTTP request. The first RI Proxy protects the first JSON patch with JSON Web Signature (JWS) to create a first JWS token. The first RI Proxy sends a second HTTPS request, including the first JWE token and the first JWS token.

### CROSS-REFERENCE TO RELATED APPLICATIONS

This application claims the benefit of U.S. Provisional Application No. 63/644,961, filed May 9, 2024, the contents of which are incorporated herein by reference.

### BACKGROUND

In Third Generation Partnership Project (3GPP) communication, service based interfaces (SBIs) include protection at the network layer or transport layer. Accordingly, network functions support the mutually authenticated transport layer security (TLS) protocol and hypertext transfer protocol secure (HTTPS). The identities in the end entity certificates are used for authentication and policy checks. Network functions shall support both server-side and client-side certificates. TLS is used for transport protection within a public land mobile network (PLMN) unless security is provided by other means. Further, TLS may be used for protection between a network function and a Security Edge Protection Proxy (SEPP).

PRotocol for N32 INterconnect Security (PRINS) is an application layer security protocol for the roaming interface N32 to provide end-to-end message protection between a Visiting PLMN Security Edge Protection Proxy (vSEPP) and home PLMN SEPP (hSEPP). PRINS is based on the security requirements and design principles for application layer security provided to 3GPP by the Global System for Mobile communications Association (GSMA), including diameter end-to-end subgroup (DESS) requirements. PRINS satisfies the end-to-end security requirements from GSMA, which is an important security improvement in Fifth Generation (5G) roaming over Fourth (4G) roaming.

The 5G roaming interface, N32, consists of N32-f, an interface for forwarding signaling messages between network functions in the two PLMNs, and N32-c, a control interface for managing N32-f, including negotiating security protection related parameters for N32-f/PRINS.

In PRINS, N32-c is an HTTP/2 connection within an end-to-end TLS tunnel between vSEPP and hSEPP. This end-to-end N32-c TLS tunnel is established over roaming intermediaries (RIs) via HTTP CONNECT, which turns RI HTTP proxies into transmission control protocol (TCP) proxies, allowing TCP payloads carrying TLS messages to be exchanged directly between vSEPP and hSEPP.

### SUMMARY

Methods, systems and apparatus for session management for a Fifth Generation (5G) roaming solution using PRotocol for N32 INterconnect Security (PRINS) with roaming intermediaries (RIs) are provided herein. In an example, a first RI Proxy receives a first hypertext transfer protocol secure (HTTPS) request, including a first JavaScript Object Notation (JSON) Web Encryption (JWE) token. Additionally or alternatively, the first RI Proxy operates in a system. Further, the first RI Proxy reconstructs a first hypertext transfer protocol (HTTP) request based on the JWE token. Then, the first RI Proxy forwards the first HTTP request to a first RI application. Also, the first RI Proxy receives a second HTTP request from the first RI application. Additionally, the first RI Proxy creates a first JSON patch based on the first HTTP request and the second HTTP request. Further, the first RI Proxy protects the first JSON patch with JSON Web Signature (JWS) to create a first JWS token.

Moreover, the first RI Proxy sends a second HTTPS request, including the first JWE token and the first JWS token. The second HTTPS request is received by a second RI Proxy, in a further example. Additionally or alternatively, the second RI Proxy operates in the system.

Additionally or alternatively, the second RI Proxy then reconstructs a third HTTP request based on the first JWE token. Further, the second RI Proxy validates the first JWS token. Also, the second RI Proxy creates a fourth HTTP request by applying first JSON patch in the JWS token to the third HTTP request.

In addition, the second RI Proxy sends the fourth HTTP request to a second RI application. Then, the second RI Proxy receives a fifth HTTP request from the second RI application. Additionally, the second RI Proxy creates a second JSON patch based on the fourth HTTP request and the fifth HTTP request.

Further, the second RI Proxy protects the second JSON patch with JWS to create a second JWS token. Moreover, the second RI Proxy sends a third HTTPS request, including the first JWE token, the first JWS token, and the second JWS token.

Additionally or alternatively, the second RI Proxy receives a first HTTPS response, including a second JWE token. Further, the second RI Proxy reconstructs a first HTTP response based on the second JWE token. Also, the second RI Proxy forwards the first HTTP response to the second RI application. Additionally, the second RI Proxy receives a second HTTP response from the second RI application. Then, the second RI Proxy creates a third JSON patch based on the first HTTP response and the second HTTP response. In addition, the second RI Proxy protects the third JSON patch with a third JWS token. Moreover, the second RI Proxy sends a second HTTPS response, including the second JWE token, the third JSON patch and the third JWS token.

Additionally or alternatively, the first RI Proxy receives the second HTTPS response, including the second JWE token and the third JSON patch with the third JWS token. Further, the first RI Proxy reconstructs a third HTTP response based on the second JWE token. Also, the first RI Proxy validates the third JSON patch and the third JWS token. In addition, the first RI Proxy creates a fourth HTTP response by applying third JSON patch to the third HTTP response. Then, the first RI Proxy sends the fourth HTTP response to a second RI application. Additionally, the first RI Proxy receives a fifth HTTP response from the second RI application. Moreover, the first RI Proxy creates a fourth JSON patch based on the fourth HTTP response and the fifth HTTP response. The first RI Proxy protects the fourth JSON patch with a fourth JWS token. The first RI Proxy then sends a third HTTPS response, including the second JWE token, the third JSON patch, the third JWS token, the fourth JSON patch, and the fourth JWS token.

Additionally or alternatively, the second HTTP request is a modification of the first HTTP request, the fifth HTTP request is a modification of the fourth HTTP request, the second HTTP response is a modification of the first HTTP response, and the fifth HTTP response is a modification of the fourth HTTP response. Additionally or alternatively, wherein the first HTTP request, the second HTTP request, the third HTTP request, the fourth HTTP request, and the fifth HTTP request are HTTP/2 requests. Additionally or alternatively, the first HTTP response, the second HTTP response, the third HTTP response, the fourth HTTP response, and the fifth HTTP response are HTTP/2 responses.

Additionally or alternatively, the first HTTP request, the second HTTP request, the third HTTP request, the fourth HTTP request, and the fifth HTTP request are HTTP/3 requests. Additionally or alternatively, the first HTTP response, the second HTTP response, the third HTTP response, the fourth HTTP response, and the fifth HTTP response are HTTP/3 responses.

Additionally or alternatively, the first HTTPS request is received from a consumer's Security Edge Protection Proxy (SEPP) (cSEPP), the third HTTPS request is sent to a producer's SEPP (pSEPP), the first HTTPS request is a reformulated request originating from a consumer's network function (cNF), and the first HTTPS response is a reformulated response originating from a producer's network function (pNF). Additionally or alternatively, the first HTTPS request is received from visiting PLMN SEPP (vSEPP), and the third HTTPS request is sent to a home public land mobile network (PLMN) SEPP (hSEPP).

In another example, a first network node may generate may generate a JSON Web token (JWT) based on connection purpose information, an originating network identity (ID), a sender's fully qualified domain name (FQDN), intended purpose information, a request uniform resource identifier (URI), a timestamp, and an expiration time. The first network node may sign the JWT to create a JWS token using a digital signature algorithm and a private key.

Additionally or alternatively, the first network node may append the JWS token to an HTTP Connect message in order to digitally sign the HTTP Connect message. In an example, the HTTP CONNECT message may be an HTTP CONNECT request message. Additionally or alternatively, the HTTP CONNECT message may be an HTTP CONNECT response message. Additionally or alternatively, the JWS token may include one or more of the connection purpose information, the originating network ID, the FQDN of the first network node, the intended purpose information, the request URI, the timestamp, the expiration time, a digital signature used in the digital signature algorithm, a public key certificate associated with the private key used to create the digital signature, and a certificate chain.

For example, the first network node may send the digitally signed HTTP CONNECT message, including HTTP CONNECT header information and the JWS token. Additionally or alternatively, the HTTP CONNECT header information may be HTTP CONNECT request header information. Additionally or alternatively, the HTTP CONNECT header information may be HTTP CONNECT response header information.

Additionally or alternatively, a second network node may receive the HTTP CONNECT message, including the HTTP CONNECT header information and the JWS token. The second network node may verify the digital signature of the digitally signed HTTP CONNECT request message based on a determination that the public key certificate associated with the digital signature is trusted, and based on a determination that the FQDN of the first network node, carried in the HTTP CONNECT request message, matches an FQDN in a SubjectAltName (SAN) field in the public key certificate.

Additionally or alternatively, the second network node may, based on the verification of the digital signature, allow an N32-c connection establishment and establish a transmission control protocol (TCP) connection towards a third network node.

### BRIEF DESCRIPTION OF THE DRAWINGS

A more detailed understanding may be had from the following description, given by way of example in conjunction with the accompanying drawings, wherein like reference numerals in the figures indicate like elements, and wherein:

FIG. 1 is an illustration of an example device;

FIG. 2 illustrates an example communication system;

FIG. 3 illustrates an example of a functional split between a next generation radio access network (NG-RAN) and Fifth Generation (5G) core (5GC);

FIG. 4 illustrates an example of a protocol stack for a user plane and a control plane;

FIG. 5 illustrates an example of a security capability negotiation between Security Edge Protection Proxies (SEPPs);

FIG. 6 illustrates an example of the architecture for PRotocol for N32 INterconnect Security (PRINS);

FIG. 7 illustrates an example of protecting an hypertext transfer protocol (HTTP) CONNECT message using a digital signature;

FIG. 8 illustrates an example of N32-c connection establishment including digitally signing the HTTP CONNECT message by a sender and verifying the digitally signed HTTP CONNECT message by a recipient; and

FIG. 9 illustrates an example of an N32-f procedure with Security Edge Protection Proxies (SEPPs) and roaming intermediaries using an hypertext transfer protocol secure (HTTPS) uniform resource identifier (URI) scheme to transfer HTTP/2 message over an N32-f connection.

### DETAILED DESCRIPTION

The underlying principle of a communication system is to enable one or more devices to communicate with one or more other devices. At a basic level, each device may need some basic components to operate. Any device referenced herein, including the hardware (e.g., virtual or physical) to run a function, software entity, application, or the like, may be understood to have at least one or more of the following components (e.g., where there may be one or more of each component): a processor, a transceiver (e.g., which may or may not be integrated with the processor), an input (e.g., microphone, keyboard, mouse, etc.), an output (e.g., port for outputting display signals, a display, a touch screen, a printer, etc.), a power source, a positioning chip (e.g., GPS, GLONASS, etc., which may or may not be integrated with the processor and/or transceiver), button (e.g., for controlling the specific function of one or more aspects of the device). These components may be operably connected to one another, meaning that there may be a direct connection or an indirect connection to one or more of the components.

A User Equipment (UE) may be interchangeable with a station (STA), a mobile station, a fixed or mobile subscriber unit, a subscription-based unit, a pager, a cellular telephone, a personal digital assistant (PDA), a smartphone, a laptop, a netbook, a computer, a server, a functional entity (e.g., virtual and/or physical) a wireless sensor, a hotspot or Mi-Fi device, an Internet of Things (IoT) device, a watch or other wearable, a head-mounted display (HMD), a vehicle, a drone, or the like.

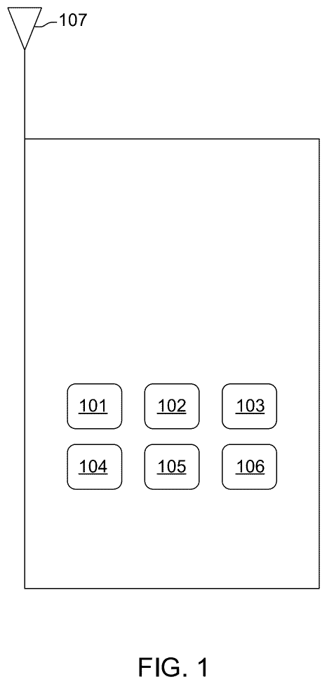

FIG. 1 is an illustration of an example device. In one case, the device may be a UE suited for mobile operation. In this example, the UE may have a processor 101, a transceiver 102, a touchscreen 103, a power source 104 (e.g., a battery), a GPS 105, one or more other components 106 (e.g., as described herein), and/or an antenna 107.

Generally, a processor may be any kind of processor, such as a processor capable of carrying out one or more of the techniques described herein. A transceiver may be configured to transmit and receive signals. In one case, there may be a separate receiver and transmitter. A transceiver may be connected to one or more antennas (e.g., MIMO technology). A transceiver may be configured to transmit RF signals. In one case, a transceiver may be configured to transmit light signals (e.g., IR, UV, laser, etc.). A transceiver may be configured to send/receive more than one type of RF signal (e.g., different radio access technologies for one transceiver, or multiple transceivers each dedicated to a specific radio access technology). A transceiver may be configured to modulate signals for transmission, and demodulate signals for reception. The UE may be capable of full duplex operation, where there is transmission and reception of some or all signals may be concurrent and/or simultaneous, for example, different timing/spacing for uplink (UL) or downlink (DL).

Different radio access technologies may be used with one or more transceivers (e.g., 802.11, WCDMA, CDMA2000, GSM, LTE, LTE-A, LTE-A Pro, NR etc.).

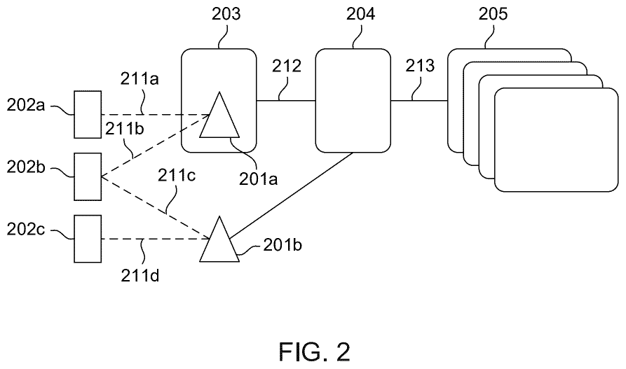

FIG. 2 illustrates an example communication system. This example may be used to illustrate multiple wireless protocols. For all wireless protocols, there may be mobile or stationary devices (e.g., 202a, 202b, 202c, such as a UE) that connect to a base station device 201a and/or 201b. In one case, this may enable a mobile device to connect to a service (e.g., a remote server) or data network (e.g., internet).

In one case, the base stations (201a, 201b) may be equivalent to, and/or interchangeable with, a base transceiver station (BTS), a NodeB, an eNode B (eNB), a Home Node B, a Home eNode B, a next generation NodeB, such as a gNode B (gNB), a new radio (NR) NodeB, a site controller, an access point (AP), a wireless router, transmission receive point (TRP), network (NW), RP (reception point), RRH (radio remote head), DA (distributed antenna), BS (base station), a sector (of a BS), and a cell (e.g., a geographical cell area served by a BS). Each base station may be representative of more than one base station (e.g., multiple transmission reception points).

A base station may be a network node. Other network nodes may be located in a network, including the core network. A network node may communicate over a wired connection, over a wireless connection, or over both. A network node may include a processor and a communications interface. A network node may be or may include a network function (NF).

Generally, a communication system may use a combination of wired and wireless connections at different points in the system. One or more wireless technologies may (e.g., channel access methods), may include code division multiple access (CDMA), time division multiple access (TDMA), frequency division multiple access (FDMA), orthogonal FDMA (OFDMA), single-carrier FDMA (SC-FDMA), zero-tail unique-word discrete Fourier transform Spread OFDM (ZT-UW-DFT-S-OFDM), unique word OFDM (UW-OFDM), resource block-filtered OFDM, filter bank multicarrier (FBMC), and the like.

A base station may be configured to transmit and/or receive wireless signals on one or more carrier frequencies, which may be referred to as a cell (not shown). A base station (201a, 201b) may communicate with one or more UEs (202a, 202b, 202c) over an air interface (211a, 211b, 211c, 211d).

In one case, one or more base stations may implement LTE radio access and NR radio access together, for instance using dual connectivity (DC) approach. Therefore, the system (e.g., and perhaps one or more UEs) may implement multiple types of radio access technologies that uses more than one type of base station (e.g., an eNB and a gNB).

In one case, the communication system may include a radio access network (RAN) 203, a core network (CN) 204, and one or more other elements represented by 205 (e.g., public switched telephone network (PSTN), the Internet, and other networks or the like).

In one scenario using FIG. 2 as an illustration, a RAN 203 may be in communication with a CN 204. The base station 201a may be an eNB, and the access technology may be based on E-UTRA (e.g., LTE, etc.). The communication system may handle data transmission from the UE 202a. The data may have varying quality of service (QoS) requirements, such as differing throughput requirements, latency requirements, error tolerance requirements, reliability requirements, data throughput requirements, mobility requirements, and the like. The CN 204 may provide call control, billing services, mobile location-based services, pre-paid calling, Internet connectivity, video distribution, etc., and/or perform high-level security functions, such as user authentication. Although not shown, the RAN 203 and/or the CN 204 may be in direct or indirect communication with other RANs that employ the same radio access technology (RAT) as the RAN 203 or a different RAT. For example, in addition to being connected to the RAN 203, which may be utilizing a NR radio access technology, the CN 204 may also be in communication with another RAN (not shown) employing another radio access technology (e.g., E-UTRA, WiFi, etc.). Each of the eNBs may be associated with a particular cell (not shown) and may be configured to handle radio resource management decisions, handover decisions, scheduling of users in the UL and/or DL, and the like. Each eNB may communicate with one another over an X2 interface (not shown).

In one scenario using FIG. 2 as an illustration, the RAN 203 and the CN 204 may employ NR radio access technologies and related protocols. The base station may be a gNB 201. The gNB(s) may implement carrier aggregation technology, where multiple component carriers may be transmitted to the UE 202a. A subset of these component carriers may be on unlicensed spectrum while the remaining component carriers may be on licensed spectrum. The UE(s) may communicate with the gNB(s) using transmissions associated with a scalable numerology (e.g., subcarrier spacing, etc.). For example, the OFDM symbol spacing and/or OFDM subcarrier spacing may vary for different transmissions, different cells, and/or different portions of the wireless transmission spectrum. The UE(s) may communicate with gNB(s) using subframe or transmission time intervals (TTIs) of various or scalable lengths (e.g., containing a varying number of OFDM symbols and/or lasting varying lengths of absolute time). The gNB(s) may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF), routing of control plane information towards Access and Mobility Management Function (AMF), and the like. The gNB(s) may communicate with one another over an Xn interface.

Not shown (e.g., but still possibly part of one or more example scenarios described herein), the CN may include one or more AMFs, one or more UPFs, one or more Session Management Functions (SMFs), and/or one or more Data Networks (DNs). In one case, the aforementioned elements may be owned and/or operated by an entity other than the CN operator.

In one scenario using FIG. 2 as an illustration, an Internet 205 may include a global system of interconnected computer networks and devices that use common communication protocols, such as the transmission control protocol (TCP), user datagram protocol (UDP) and/or the internet protocol (IP) in the TCP/IP internet protocol suite.

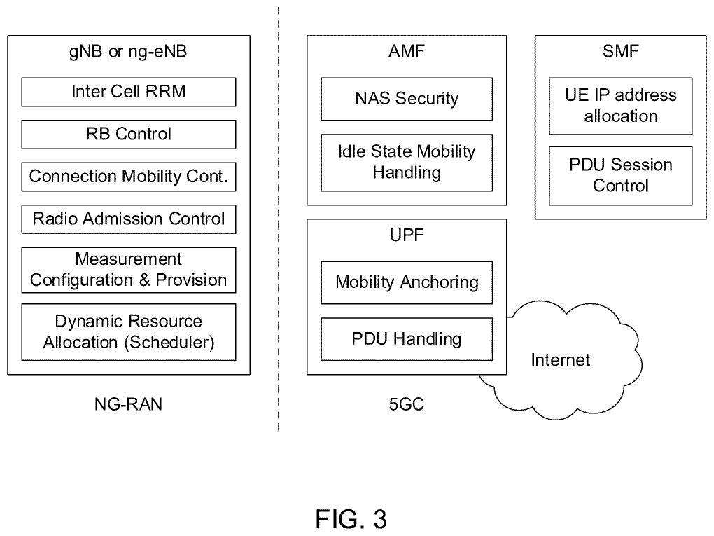

FIG. 3 illustrates an example of a functional split between the next generation radio access network (NG-RAN) and Fifth Generation (5G) core (5GC). The AMF may be connected to one or more gNB the RAN via an N2 interface and may serve as a control node. For example, the AMF may be responsible for authenticating a UE's support for network slicing (e.g., handling of different protocol data unit (PDU) sessions with different requirements), selecting a particular SMF, management of the registration area, termination of non-access stratum (NAS) signaling, mobility management, and the like. Network slicing may be used by the AMF in order to customize CN support for one or more UEs based on the types of services being utilized by the respective UE. For example, different network slices may be established for different use cases such as services relying on ultra-reliable low latency (URLLC) access, services relying on enhanced massive mobile broadband (eMBB) access, services for MTC access, and the like. The AMF may provide a control plane function for switching between the RAN and other RANs that employ other radio technologies (e.g., as described herein). The SMF may be connected to an AMF in the CN via an N11 interface. The SMF may also be connected to a UPF in the CN via an N4 interface. The SMF may select and control the UPF and configure the routing of traffic through the UPF. The SMF may perform other functions, such as managing and allocating UE IP address, managing PDU sessions, controlling policy enforcement and QoS, providing DL data notifications, and the like. A PDU session type may be IP-based, non-IP based, Ethernet-based, and the like. The UPF may be connected to one or more gNB in the RAN via an N3 interface, which may provide a UE with access to packet-switched networks, such as the Internet, to facilitate communications between one or more UEs and IP-enabled devices. The UPF may perform other functions, such as routing and forwarding packets, enforcing user plane policies, supporting multi-homed PDU sessions, handling user plane QoS, buffering DL packets, providing mobility anchoring, and the like. The CN may facilitate communications with other networks. For example, the CN may provide a UE with access to the other networks 212, which may include other wired and/or wireless networks that are owned and/or operated by other service providers. In one example, the UEs may be connected to a local DN through a UPF via an N3 interface to the UPF and an N6 interface between the UPF and the DN. As discussed herein, a NR RAN may be called an NG-RAN and a NR CN may be called a 5GC.

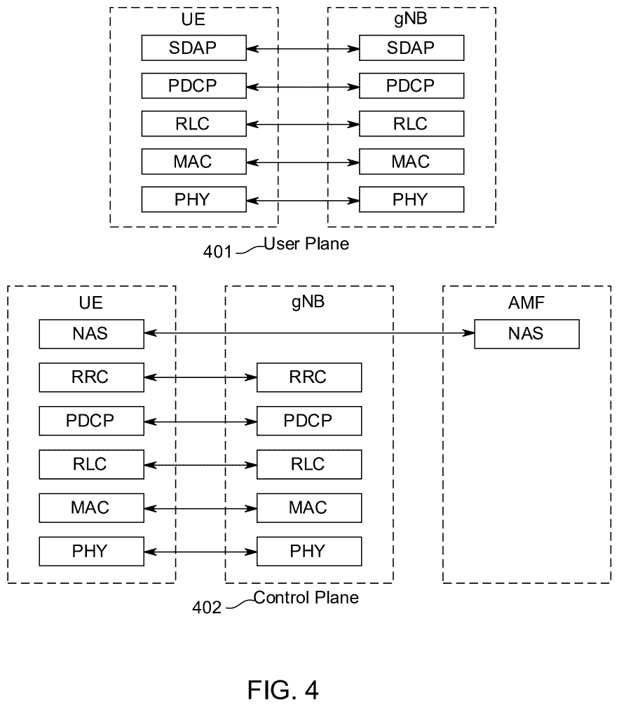

FIG. 4 illustrates an example of a protocol stack for the user plane and control plane. The user plane protocol stack 401 and the control plane stack 402. A higher layer may refer to one or more layers in a protocol stack, or a specific sublayer within the protocol stack. The protocol stack may comprise of one or more layers in a UE or a network node (e.g., eNB, gNB, other functional entity, etc.), where each layer may have one or more sublayers. Each layer/sublayer may be responsible for one or more functions. Each layer/sublayer may communicate with one or more of the other layers/sublayers, directly or indirectly. In some cases, these layers may be numbered, such as Layer 1, Layer 2, and Layer 3. For example, Layer 3 may comprise of one or more of the following: NAS, Internet Protocol (IP), and/or Radio Resource Control (RRC). For example, Layer 2 may comprise of one or more of the following: Packet Data Convergence Control (PDCP), Radio Link Control (RLC), and/or Medium Access Control (MAC). For example, Layer 3 may comprise of physical (PHY) layer type operations. The greater the number of the layer, the higher it is relative to other layers (e.g., Layer 3 is higher than Layer 1). In some cases, the aforementioned examples may be called layers/sublayers themselves irrespective of layer number, and may be referred to as a higher layer as described herein. For example, from highest to lowest, a higher layer may refer to one or more of the following layers/sublayers: a NAS layer, a RRC layer, a PDCP layer, a RLC layer, a MAC layer, and/or a PHY layer. Any reference herein to a higher layer in conjunction with a process, device, or system will refer to a layer that is higher than the layer of the process, device, or system. In some cases, reference to a higher layer herein may refer to a function or operation performed by one or more layers described herein. In some cases, reference to a high layer herein may refer to information that is sent or received by one or more layers described herein. In some cases, reference to a higher layer herein may refer to a configuration that is sent and/or received by one or more layers described herein.

The examples provided herein are based on the Third Generation Partnership Project (3GPP) 5G architecture and the procedures associated with the 5GC. One with ordinary skills in the art may envision other technologies being used and the same concepts may apply. Examples of other technologies may be 4G, CBRS, cdma2000, 6G, and beyond. The examples provided herein should not limit the scope of the methods.

The 3GPP standards support the access to the 5GC via a wireline access network (AN). A wireline 5G access network (W-5GAN) is a wireline AN that may connect to a 5GC. For example, devices in a home local access network (LAN), such as a residential gateway (RG), may connect to the 5GC via a Wireline Access Gateway Function (W-AGF) in the W-5GAN. The W-AGF is a network function that may interface with the 5GC Control Plane (CP) and the 5GC User Plane (UP) functions, via N2 and N3 interfaces, respectively. In the example of a home LAN, the W-AGF may provide connectivity towards the 5GC to the home LAN devices using one or more N2 and N3 interfaces with the 5GC.

A residential gateway (RG) is a device providing, for example, voice, data, broadcast video, video on demand, etc. to other devices in specific locations referred to as customer premises. In this example, an RG may have one or more processors, such as Central Processing Units (CPUs), Graphical Process Units (GPUs), Front End Processors (FEPs), Communication Processors (CPs), Field Programmable Gate Arrays (FPGAs), Vision Processing Units (VPU), Quantum Processing Units (QPUs), Associative Processing Units (APUs), and Tensor Processing Units (TPUs); a baseband radio; one or more transceivers; one or more antennas; storage, such as HDD, SSD, NVM, RAM, ROM, memory, cache; memory controller(s), a touchscreen, and a power source. The RG may also have one or more of its functions virtualized.

An RG may contain functionality that enables devices behind it to also connect with the 5GC and obtain 5G services. The devices behind the RG may be of different types, such as 3GPP-capable devices (e.g., UEs), authenticable non-3GPP (AUN3) devices, non-authenticable non-3GPP (NAUN3) devices, or non-5G-Capable over WLAN (N5CW) devices. An RG may be 5G-capable, in which case it is referred to as a 5G-RG, or it may be non-3GPP capable, in which case it is referred to as a Fixed Network RG (FN-RG). The 5G-RG may play the role of a UE.

While reference to 5GC is mentioned to assist in explaining the concepts of this invention, the examples and techniques discussed herein are equally applicable to other generations of wireless technologies, and may interchangeable with 3G, 4G, 6G, etc.

There are benefits to both users and operators to allow RGs, and devices that are non-3GPP capable and are behind RGs, to access the 3GPP 5G 5GC. The 5GC provides several features that may be beneficial, independent of the type of access technology used by the devices accessing the network. Users may receive the benefits of the rich 5G features, and operators may have means to charge for the usage of such features.

As an example, there may be one or more procedures that enable access to the Evolved Packet Core (EPC) or the 5GC via non-3GPP RATs. One such example is a UE accessing the 5GC using WLAN.

Additionally, there may be one or more procedures for supporting access to the 5GC via a wireline AN. As an example, a home LAN may be connected to the 5GC via an RG. The RG may contain functionality that enables devices behind it to connect with the 5GC and obtain 5G services.

The 5G-RG and the W-AGF may interface with the 5GC Control Plane (CP) and the 5GC User Plane (UP) functions, via N2 and N3 interfaces, respectively. They may enable authentication, registration and packet data network (PDN) connectivity procedures associated with the devices behind the RG. They may facilitate the provisioning of differentiated services to the devices behind the RG, via the interfaces with the 5GC.

Between two operator networks, Security Edge Protection Proxies (SEPPs) negotiate security capabilities between themselves. A security capability negotiation over the N32-c interface allows the SEPPs to negotiate which security mechanism to use for protecting NF service-related signaling over the N32-f interface. There shall be an agreed security mechanism between a pair of SEPPs before conveying NF service-related signaling over the N32-f interface. A network node may be or may include an SEPP.

When an SEPP notices that it does not have an agreed security mechanism for N32-f interface protection with a peer SEPP or if the security capabilities of the SEPP have been updated, the SEPP shall perform security capability negotiation with the peer SEPP over the N32-c interface in order to determine, which security mechanism to use for protecting NF service-related signaling over the N32-f interface. Certificate based authentication shall follow the profiles previously given, such as in 3GPP TS 33.210, clause 6.2. The contents of 3GPP TS 33.210 are incorporated by reference herein as if fully set forth in their entity.

A mutually authenticated transport layer security (TLS) connection as defined in clause 13.1 of 3GPP TS 33.501 shall herein be used for protecting security capability negotiation. The contents of 3GPP TS 33.501 are incorporated by reference herein as if fully set forth in their entity. The TLS connection shall provide integrity, confidentiality and replay protection.

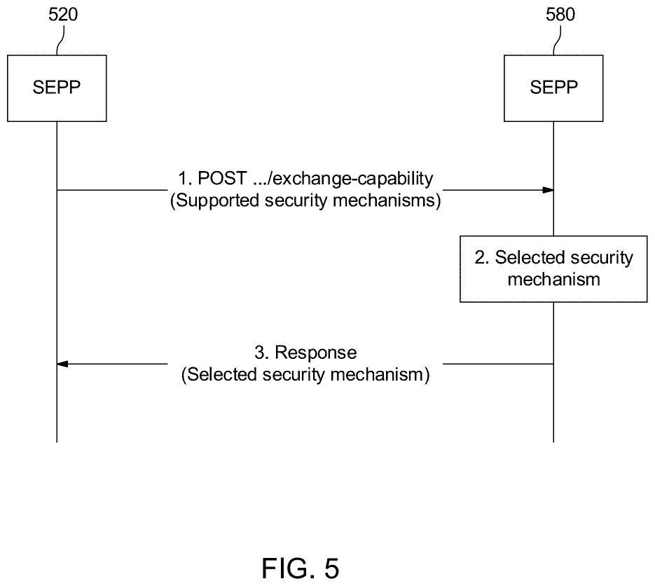

FIG. 5 illustrates an example of a security capability negotiation between Security Edge Protection Proxies (SEPPs). As shown in an example in the first step in FIG. 5, a SEPP 510, which initiated and completed the TLS connection establishment with the SEPP 580, shall issue a POST request to the exchange-capability resource of the responding SEPP 580 including the initiating SEPP's supported security mechanisms for protecting the NF service-related signaling over N32-f (see Table 1, below). The security mechanisms shall be ordered in the initiating SEPP's priority order.

In a second step, the responding SEPP 580 shall compare the received security capabilities to its own supported security capabilities and selects, based on its local policy (for example, based on whether there are roaming intermediary (RI) providers on the path between the SEPPs), a security mechanism, which is supported by both the initiating SEPP 520 and the responding SEPP 580. In a third step, the responding SEPP 580 shall respond to the initiating SEPP 520 with the selected security mechanism for protecting the NF service-related signaling over N32. Table 1 below includes NF service-related signaling traffic protection mechanisms over the N32 interface.

TABLE 1

| N32-f protection mechanism | Description |
|---|---|
| Mechanism 1 | PRINS |
| Mechanism 2 | TLS |
| Mechanism n | Reserved |

If the selected security mechanism is PRotocol for N32 INterconnect Security (PRINS), the SEPPs shall behave as specified in clause 13.2 of 3GPP TS 33.501. If the selected security mechanism is PRINS, the SEPP may indicate a security profile.

Further, a security profile can for example include pre-selected cipher suites, default modification policies and default data_type encryption policies and/or a list of information elements (IEs) to be protected, during the N32-c negotiation process.

If the selected security mechanism is TLS, the SEPPs shall behave as specified in clause 13.1.2 of 3GPP TS 33.501, tear down the N32-c connection and forward the NF service-related signaling over the N32-f interface using a TLS connection. If the selected security mechanism is a mechanism other than the ones specified in Table 1, the two SEPPs shall terminate the N32-c TLS connection.

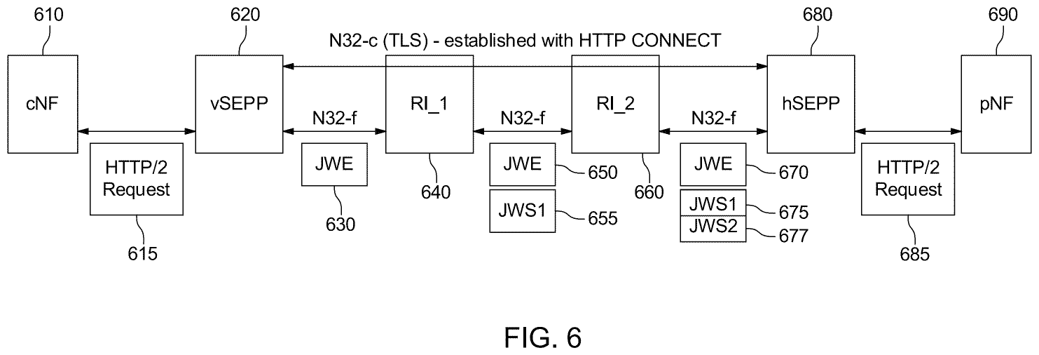

FIG. 6 is illustrates an example of the architecture for PRINS. In an example shown in FIG. 6, PRINS is used for end-to-end signaling security between a vSEPP 620 in a vPLMN and an hSEPP 680 in a hPLMN. PRINS uses two different protocols for N32. The first protocol is end-to-end TLS for an N32-c connection. Specifically, PRINS uses HTTP CONNECT to establish the end-to-end TLS between vSEPP 620 and hSEPP 680.

The second protocol is end-to-end application layer security for an N32-f connection. The TLS security for the N32-f connection may use Internet Protocol Security (IPSec), TLS VPN, or both. Signaling messages are protected in the application layer with information elements protected with confidentiality, integrity based on policy, or both.

Within the end-to-end TLS tunnel between vSEPP 620 and hSEPP 680, one or more of the following N32-c handshake procedures can be executed: the Security Capability Negotiation Procedure (including one or more of: the Parameter Exchange Procedure, the Cipher Suite Negotiation, the Protection Policy Exchange, and the Security Information List); the N32-f Termination Procedure; and the N32-f Error Reporting Procedure. These procedures may be executed as explained in 3GPP TS 29.573. The contents of 3GPP TS 29.573 are incorporated by reference herein as if fully set forth in their entity. After N32-c procedures are completed, the N32-f interface can be initiated to forward NF signaling messages between the vSEPP 620 and hSEPP 680.

In an example shown in FIG. 6, a signaling message may originate in a consumer's NF (cNF) 610 and, accordingly, the cNF 610 may send an HTTP/2 request 615 to the vSEPP 620. In an example, vSEPP 620 may be a consumer's SEPP (cSEPP). Additionally or alternatively, the hSEPP 680 may be a producer's SEPP (pSEPP).

The N32-f/PRINS protects signaling messages in the application layer by reformulating an original HTTP/2 message into a JavaScript Object Notation (JSON) Web Encryption (JWE) token that is protected for integrity and confidentiality, for example, JWE tokens 630, 650, 670. Protection policies negotiated between the vSEPP 620 and hSEPP 680 (within an end-to-end TLS tunnel) dictates which information elements are protected for confidentiality, and which are modifiable by RIs, such as R1_1 640 and RI_2 660.

RIs can modify the protected JWE token by creating and appending a JSON patch that indicates the desired values of the modifiable information elements in the JWE token. A network node may be or may include an RI. For example, RI_1 640 may create JSON patch JWS1 655 and append it to JWE token 650. RI_2 660 may forward the JWE and patch as JWE 670 with JWS1 675, and further create and append JWS2 677, as shown in FIG. 6. Those JSON patches, when applied by a receiving SEPP, such as hSEPP 680, would result in a signaling message in the desired states of the RIs 640, 660. Further, hSEPP 680 may validate the JWE 670, JWS1 675 and JWS2 677, and check the modifications against its security policy. If all validations succeed, the pSEPP will recreate the HTTP/2 request message as HTTP/2 request 685. The hSEPP 680 sends the HTTP/2 request 685 to a producer's NF (pNF) 690. A receiving SEPP has a clear understanding of which entities on the signaling path has made what changes to the signaling message, achieving an important security property, namely attributability. Based on the protection policy, particularly the modification policy, a receiving SEPP can decide whether or not to accept a modification by an RI.

PRINS achieves an important objective of end-to-end security (between the vSEPP 620 and hSEPP 680) in the application layer for 5G roaming, while allowing authorized RIs 640, 660 to modify signaling messages as needed, albeit with additional complexity and overhead. PRINS was designed and specified based on the recommendations (application layer security) and requirements (mandatory to implement and use) provided to 3GPP by GSMA.

However, despite current PRINS achieving this important objective, modifications to PRINS described herein will improve its security and efficiency for all system users. The modifications to PRINS described herein address several problems with the current PRINS. For example, in current PRINS, N32-c is an HTTP/2 connection within an end-to-end TLS tunnel between vSEPP and hSEPP. This end-to-end TLS tunnel is established over the HTTP proxies in RIs by HTTP CONNECT, which turns all HTTP proxies on the path between vSEPP and hSEPP into TCP proxies. By accepting an HTTP CONNECT request, an HTTP proxy in RI agrees to function as a TCP proxy by blindly forwarding TCP payloads carrying TLS messages including TLS handshaking messages without processing and responding to those messages. In this way, an end-to-end TLS tunnel is established between vSEPP and hSEPP to protect subsequent N32-c handshake procedures.

This end-to-end TLS tunnel provides confidentially, integrity, and anti-reply protection for N32-c handshake procedures. It can also export keying materials to be used by the symmetric crypto algorithms to protect N32-f/PRINS connection in the application layer.

While the end-to-end TLS tunnel serves the purpose of protecting N32-c/PRINS between vSEPP and hSEPP, it is problematic from the perspective of RIs. More specifically, it requires RIs to support HTTP CONNECT, which introduces both business and security risks to RIs.

For example, by supporting HTTP CONNECT, RIs allow their HTTP proxies to become TCP proxies between vSEPP and hSEPP, potentially losing visibility and control of what are being transmitted through the TCP tunnel (e.g., when the tunnel is encrypted using TLS). Although legitimate SEPPs would only transmit N32-c handshake procedures within the end-to-end TLS tunnel, any web traffic such as N32-f signaling messages and non-web traffic such as mail traffic can be transmitted within the tunnel. N32-f signaling messages, if sent through the tunnel by untrusted SEPPs, prevent RIs from offing any value added services, resulting in business loss. No-web traffic such as email spams or malware, if transmitted through the tunnel by malicious parties, would result in security risks for the RIs.

Unfortunately, in current, unmodified PRINS, HTTP CONNECT requests are sent over TCP without any cryptographic authentication. Thus, not only legitimate vSEPP and pSEPP, but any parties with access to the interconnection networks, are able to tunnel through RIs.

A recipient of HTTP CONNECT can only perform access control based on the IP address, which can be spoofed and requires substantial overhead in maintaining the allowed or disallowed IP list. Currently, 3GPP TS 29.573, section 5.5.2, specifies that HTTP CONNECT request shall include the following information in the 3gpp-Connect-Req-Infor header: Connect-purpose=“n32c”; Originating-network-id=vSEPP's PLMN-id; Sender-fqdn=vSEPP's fqdn or RI_1's fqdn; and Intended-n32-purpose=ROAMING). While a recipient may perform access control based on the content in the above header, its content is not cryptographically protected, thus can be spoofed, in current, unmodified PRINS.

In current, unmodified PRINS, there appears no easy way for RIs to ensure that only N32-c handshake procedures are being transmitted within the tunnel, since RIs cannot inspect the encrypted tunnel. One mitigation is for RIs to impose rate limit on N32-c connection. This is possible, but would introduce configuration overhead for RIs. Even if rate limit on N32-c can be implemented by RIs, it only mitigates concerns on bandwidth usage, it does not provide any assurance that only N32-c procedures are being transmitted within the tunnel. Particularly, RIs cannot prove that their networks are not being misused, for example, to carry out malicious activities.

Without the modifications and example solutions provided herein, the best an RI can do to mitigate the misuse of HTTP CONNECT appears to be access control based on allowed list of IP addresses. This would once again introduce management overhead and impose deployment constraints, but without mitigating risks from misbehaving legitimate SEPPs.

An example provided herein includes digitally signing the HTTP CONNECT request. The digital signature is carried in an HTTP header, for example, 3gpp-Connect-Req-info header: for example, Connect-signature=digital-signature, Connect-auth-token=JWS-token. Further, the input that is digitally signed may include the current content in the 3gpp-Connect-Req-info header, including the request uniform resource identifier (URI) such as the fully qualified domain name (FQDN) of the hSEPP and port number. Further, the input may include additional attributes to be added to the header, such as a timestamp and an expiration time.

The public key certificate associated with the private key used for signing, along with the chain of certificates except the root CA certificate should also be included in the header. Further, the public key certificate or certificate chain can be downloaded from a URL resource. Additionally or alternatively, the URL resource may provide the certificate or certificate chain itself.

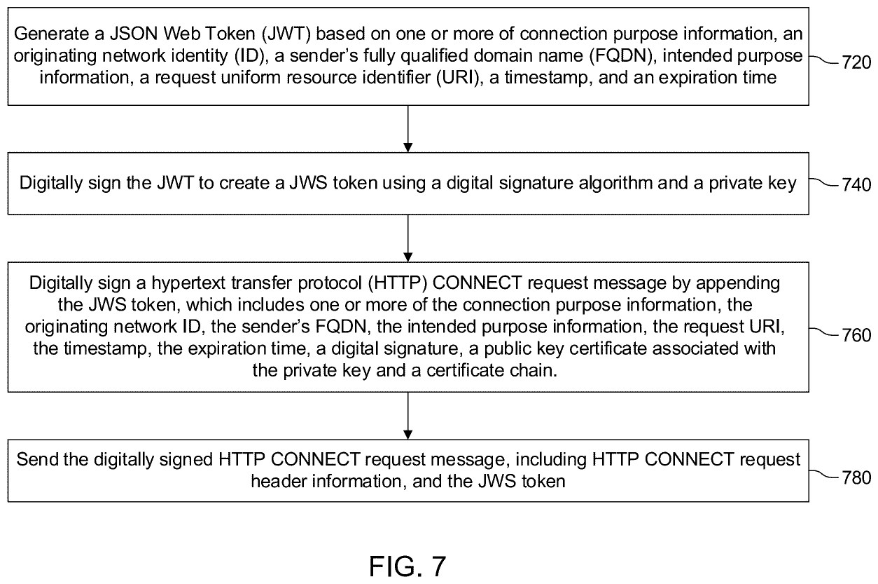

FIG. 7 illustrates an example of protecting an hypertext transfer protocol (HTTP) CONNECT message using a digital signature. As shown in an example in FIG. 7, a device generates a JSON Web token (JWT) based on one or more of connection purpose information, an originating network identity (ID), a sender's FQDN, intended purpose information, a request URI, a timestamp, and an expiration time 720. In an example, the device may be a network node. For example, the device may be an SEPP, such as a cSEPP, hSEPP, pSEPP or vSEPP. Additionally or alternatively, the device may be a RI. Additionally or alternatively, the device may be a UE.

Further, the device digitally signs the JWT to create a JWS token using a digital signature algorithm and a private key 740. Further, the JWS token may include one or more of the connection purpose information, the originating network ID, the sender's FQDN, the intended purpose information, the request URI, the timestamp, the expiration time, a digital signature used in the digital signature algorithm, a public key certificate associated with the private key used to create the digital signature, and a certificate chain.

In an example, the timestamp records the time of creation of the JWT. Additionally or alternatively, the timestamp records the time of creation of the JWS token. In a further example, the expiration time is a time that the JWT becomes invalid. Additionally or alternatively, the expiration time is a time that the JWS token becomes invalid.

Also, the device appends the JWS token to the HTTP Connect message in order to digitally sign the HTTP Connect message 760. In an example, the HTTP CONNECT message may be an HTTP CONNECT request message. Additionally or alternatively, the HTTP CONNECT message may be an HTTP CONNECT response message.

In addition, the device may send the digitally signed HTTP CONNECT request, including the JWS token 780. Additionally or alternatively, a recipient may receive the HTTP CONNECT message. Additionally or alternatively, the HTTP CONNECT message may include HTTP Connect message header information.

Moreover, the HTTP CONNECT message header information of the HTTP Connect message may include the connection purpose information, in an example. Additionally or alternatively, the HTTP CONNECT message header information includes the originating network ID. Additionally or alternatively, the HTTP CONNECT message header information includes the sender's FQDN. Additionally or alternatively, the HTTP CONNECT message header information includes the intended purpose information.

In another example, an HTTP CONNECT message may be digitally signed by including a digital signature in the HTTP CONNECT message header information. Additionally or alternatively, the HTTP CONNECT message header information includes an expiration time at which the digital signature becomes invalid. Additionally or alternatively, the HTTP CONNECT message header information includes in the algorithm used for the digital signature. Further, the device may send the digitally signed HTTP CONNECT request. In an example, the device may send the digitally signed HTTP CONNECT request without the JWS token.

Additionally or alternatively, the recipient may be a network node. For example, the device may be an SEPP, such as a cSEPP, hSEPP, pSEPP or vSEPP. Additionally or alternatively, the device may be a RI. In an example where the network node sends the HTTP CONNECT message, the recipient may be another network node. Additionally or alternatively, the recipient may be a UE. In an example where the UE sends the HTTP CONNECT message, the recipient may be another UE.

A recipient, such as an RI, can verify the digital signature of the HTTP CONNECT message (which may be a request or response), and check if the public key certificate associated with the digital signature is trusted, including if the sender's FQDN in the header matches the FQDN in the certificate's SubjectAltName (SAN) field. If either fails, it can reject the HTTP CONNECT message. Accordingly, the recipient can reject the request or response. In this way, only authorized SEPP with trusted public key certificate can send HTTP CONNECT message to an RI, thus mitigating the risks for RI. Further, an RI can validate HTTP CONNECT message based on the sender's public key certificate, without depending on statically configured IP address information, thus significantly reducing operational overhead for RI.

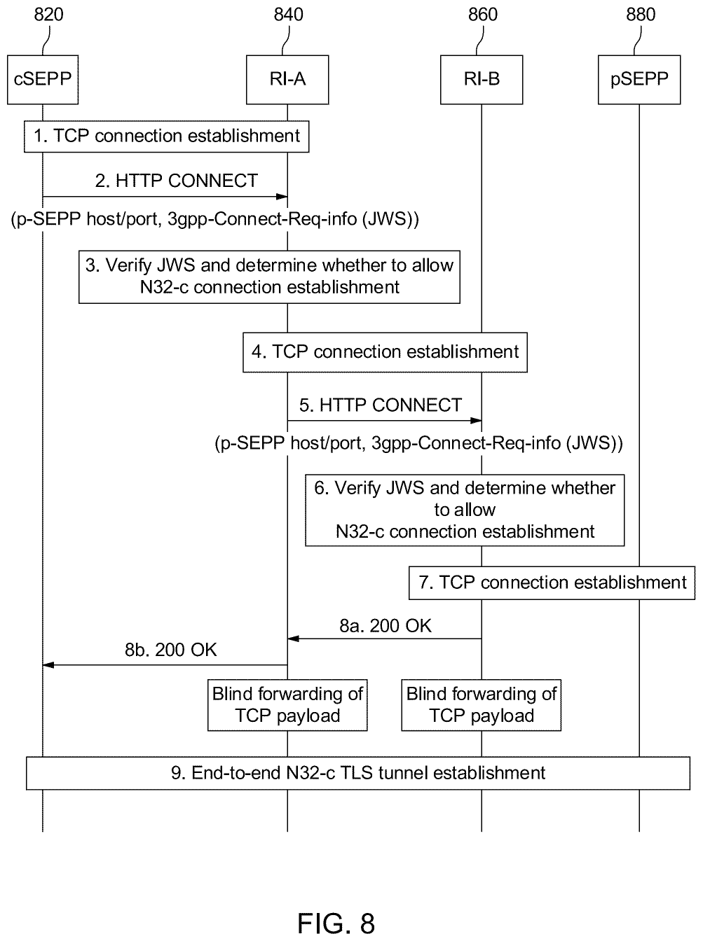

FIG. 8 illustrates an example of N32-c connection establishment including digitally signing the HTTP CONNECT message by a sender and verifying the digitally signed HTTP CONNECT message by a recipient. Example procedures in FIG. 8 include one or more example solutions provided above.

In an example shown in FIG. 8, a cSEPP 820 may establish a TCP connection with an RI-A 840 in a first step. The cSEPP 820 may be or may in a first network node. Further, the RI-A 840 may be or may be in a second network node.

In a second step, the cSEPP 820 includes the following information in a 3gpp-Connect-Req-Infor header in a first HTTP CONNECT request message: an HTTP CONNECT purpose set to n32c to indicate that a TCP connection requested to be established is to set up an N32-c connection between the cSEPP 820 and a pSEPP 880; the cSEPP's PLMN ID or stand-alone non-publish network (SNPN) ID; and the cSEPP's FQDN. Further, the authority of the first HTTP CONNECT request message shall contain the FQDN of the pSEPP 880. The pSEPP 880 may be or may be in a third network node.

Moreover, the cSEPP 820 may also include the following information in the first HTTP CONNECT request in the 3gpp-Connect-Req-Infor header: the intended one or more purposes of the N32 connection. Also, the first HTTP CONNECT request message may include host and port information of the pSEPP 880. In addition, the cSEPP 820 digitally signs the first HTTP CONNECT request message by appending a first JWS token, for example, by using one or more of the example solutions above. For example, the cSEPP 820 may append the first JWS token using an example shown in FIG. 7 and related text.

Accordingly, the cSEPP 820 sends the first HTTP CONNECT request message, including the 3gpp-Connect-Req-Infor header and the first JWS token, to the RI-A 840 to request that the RI-A 840 establish a TCP connection towards the p-SEPP 880. The RI-A 840 may receive the first HTTP CONNECT request message from the cSEPP 820.

In a third step, the RI-A 840 determines whether to allow or disallow the N32-c connection establishment. Accordingly, the RI-A 840 verifies the first JWS token. The verification may include one or more of the examples regarding JWS token verification provided above. For example, the RI-A 840 may check if the public key certificate associated with the digital signature is trusted, including if the FQDN of the cSEPP 820 in the header matches the FQDN in the certificate's SAN field.

Further the RI-A 840 checks the PLMN ID or SNPN ID of the cSEPP 820, and the PLMN ID or SNPN ID of the pSEPP 880. Also, the RI-A 840 may consider any or a combination of the following information for the above determination: the HTTP connect purpose, for example, the RI-A 840 may accept an HTTP CONNECT request message only for the purpose of establishing an N32-c connection; or the intended N32 purpose, for example, the RI-A 840 may accept to establish the N32-c connection between the two PLMNs only for specific purposes.

Accordingly, the RI-A 840 determines whether to allow or disallow the N32-c connection establishment based on the verification of the first JWS token, one or more roaming agreements of the RI-A 840, and one or more of the above parameters.

In a fourth step, if the RI-A 840 allows the establishment of the N32-c connection, the RI-A 840 will establish a TCP connection towards an RI-B 860. In an example, the RI-B 860 may be or may be in a second network node.

In a fifth step, the RI-A 840 sends a second HTTP CONNECT request message to the RI-B 860. Specifically, the RI-A 840 includes the following information in a 3gpp-Connect-Req-Infor header in a second HTTP CONNECT request message: an HTTP CONNECT purpose set to n32c to indicate that a TCP connection requested to be established is to set up an N32-c connection between the cSEPP 820 and a pSEPP 880; the cSEPP's PLMN ID or stand-alone non-publish network (SNPN) ID; and the FQDN of the RI-A 840. Further, the authority of the first HTTP CONNECT request message shall contain the FQDN of the pSEPP 880.

Moreover, the RI-A 840 may also include the following information in the second HTTP CONNECT request in the 3gpp-Connect-Req-Infor header: the intended one or more purposes of the N32 connection. Also, the second HTTP CONNECT request message may include host and port information of the pSEPP 880. In addition, the RI-A 840 digitally signs the second HTTP CONNECT request message by appending a second JWS token, for example, by using one or more of the example solutions above. For example, the RI-A 840 may append the second JWS token using an example shown in FIG. 7 and related text.

Accordingly, the RI-A 840 sends the second HTTP CONNECT request message, including the 3gpp-Connect-Req-Infor header and the second JWS token, to the RI-B 860 to request that the RI-B 860 establish a TCP connection towards the p-SEPP 880. The RI-B 860 may receive the second HTTP CONNECT request message from the RI-A 840.

In a sixth step, the RI-B 860 determines whether to allow or disallow the N32-c connection establishment. Accordingly, the RI-B 860 verifies the second JWS token. The verification may include one or more of the examples regarding JWS token verification provided above. For example, the RI-B 860 may check if the public key certificate associated with the digital signature is trusted, including if the FQDN of the RI-A 840 in the header matches the FQDN in the certificate's SAN field.

Further the RI-B 860 checks the PLMN ID or SNPN ID of the cSEPP 820, and the PLMN ID or SNPN ID of the pSEPP 880. Also, the RI-B 860 may consider any or a combination of the following information for the above determination: the HTTP connect purpose, for example, the RI-B 860 may accept an HTTP CONNECT request message only for the purpose of establishing an N32-c connection; or the intended N32 purpose, for example, the RI-B 860 may accept to establish the N32-c connection between the two PLMNs only for specific purposes.

Accordingly, the RI-B 860 determines whether to allow or disallow the N32-c connection establishment based on the verification of the first JWS token, one or more roaming agreements of the RI-B 860, and one or more of the above parameters.

In a seventh step, if the RI-B 860 allows the establishment of the N32-c connection, the RI-B 860 will establish a TCP connection towards a pSEPP 880.

Upon successful processing of the request and establishment of the TCP connection towards the pSEPP 800, the RI-B 860 responds to the RI-A 840 with a first 200 OK status code response in a step 8a. Additionally or alternatively, the RI-B 860 may include one or more of the following in information in the 3gpp-Connect-Resp-Info header in a first HTTP CONNECT response message sent to the RI-A 840: the allowed N32 purposes for the N32 connection, which may be a subset of the N32 purposes signaled in the second HTTP CONNECT request message; the FQDN of the pSEPP 880, if the RI-B 860 has overwritten the p-SEPP FQDN received from the RI-A 840 that the RI-A 840 should use for sending its N32-c requests to the pSEPP 880.

Upon receiving the first 200 OK status code response from the RI-B 860, the RI-A 840 will send a second 200 OK status code response to the cSEPP 820, in a step 8b. Additionally or alternatively, the RI-A 840 may include one or more of the following in information in the 3gpp-Connect-Resp-Info header in a second HTTP CONNECT response message sent to the cSEPP 820: the allowed N32 purposes for the N32 connection, which may be a subset of the N32 purposes signaled in the first HTTP CONNECT request message; the FQDN of the pSEPP 880, if the RI-A 840 has overwritten the p-SEPP FQDN received from the cSEPP 820 that the cSEPP 820 should use for sending its N32-c requests to the pSEPP 880.

Further, the RI-A 840 and the RI-B 860 may engage in blind forwarding of one or more TCP payloads, including the blind forwarding of data. Moreover, in a ninth step, the cSEPP 820 will establish an end-to-end N32-c TLS tunnel connection with the pSEPP 880.

In current PRINS, an RI consists of only one entity, which needs to have both the business logic to understand how to modify an N32-f message and the security capability to create a JSON patch signed with JWS to represent the modification.

Solutions are provided herein to allow an RI to separate its business logic from its security capability. More specifically, an RI consists of two logical entities, an RI Proxy (RI_Proxy) and an RI Application (RI_Application). The RI_proxy performs security related functions, for example, reformulating a PRINS JWE token into an HTTP/2 message, creating a JSON patch representing the difference between two HTTP/2 messages, and digitally signing the JSON patch with JWS. The RI_Application process regular HTTP/2 message, and performs message modification based on business logic.

A third shortcoming of PRINS is related to the transport protection of the N32-f connection. In the current PRINS, either network domain security (NDS)/IP domain security or TLS VPN (clause 13.1.2 of 3GPP TS 33.501) is required for protecting N32-f connection. However, neither approach allows an SEPP to authenticate a recipient (e.g., an RI) against a requesting URI, since NDS/IP domain security or TLS VPN are established independent of requesting URIs. With the example solutions provided herein, N32-f requests and responses use the hypertext transfer protocol secure (HTTPS) scheme, which require a sender to validate a requesting URI domain against a recipient's identity in its TLS certificate. In this way, only the legitimate parties can receive the requests.

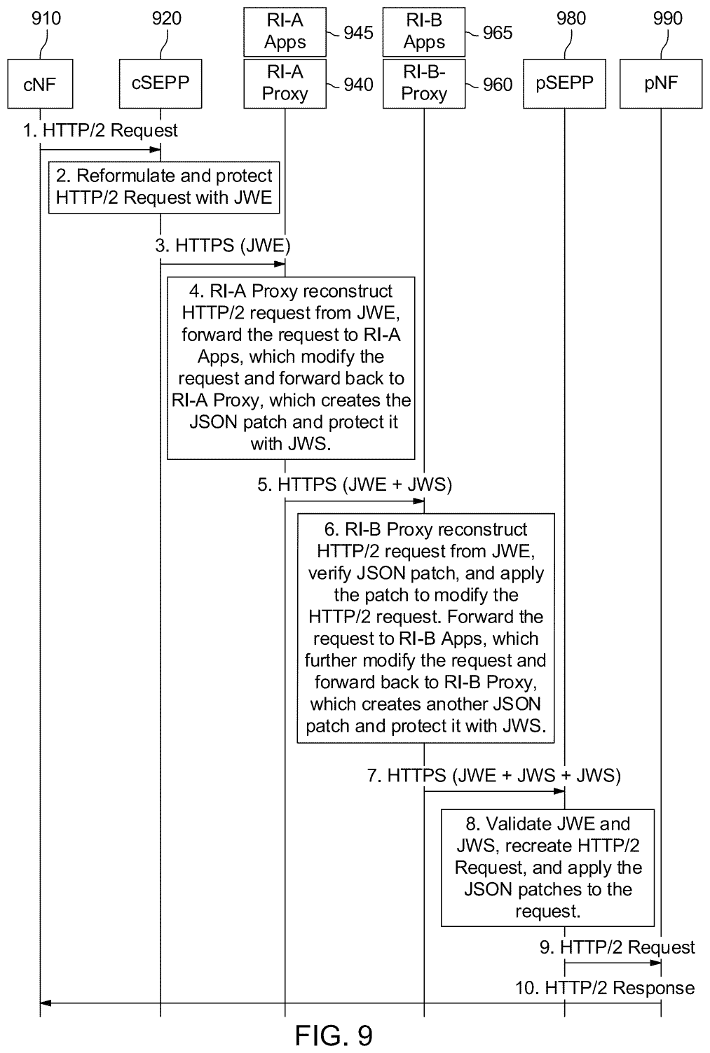

FIG. 9 illustrates an example of an N32-f procedure to transfer HTTP/2 messages over an N32-f connection. Each RI consists of an RI proxy and an RI application components, and an HTTPS scheme is used for the N32-f connection.

In a first step in an example shown in FIG. 9, a cNF 910 sends an HTTP/2 request to an cSEPP 920.

In a second step, the cSEPP 920 shall reformulate and protect the HTTP/2 request message with JWE. The protection may be as specified in 3GPP TS 33.501, section 13.2.4.3. Accordingly, the cSEPP 920 creates a JWE token.

In a third step, the cSEPP 920 shall send the JWE token, in an HTTPS message, to an RI-A Proxy 940 over TLS.

In a fourth step, the RI-A Proxy 940 reconstructs the HTTP/2 request from the JWE token, forwards the HTTP/2 request (#1) to an RI-A application (Apps) 945, which may modify the request based on its business logic to create HTTP/2 message #2. The RI-A application 945 forwards the modified HTTP/2 message (#2) back to RI-A Proxy 940. The RI-A proxy 940 shall create an Operations JSON patch document to describe the differences between the original HTTP/2 message (#1) and the modified message (#2) in a regular JSON document (in other words, not a JSON patch). The RI-A 940 shall digitally sign the resulted JSON object, which creates the JSON patch and protect it with JWS. In an example, the RI-A 940 may sign the JSON object using the procedures described in 3GPP TS 33.501, section 13.2.4.5.2.

In a fifth step, the RI-A 940 shall send, to the RI-B 960 over TLS, the JWE token generated by the cSEPP 920, and the JWS token generated by itself. The JWE token and JWS token may be sent in an HTTPS message.

In a sixth step, the RI-B Proxy 960 reconstructs the HTTP/2 request (#1) from the JWE token, verifies the JWS token, applies the JSON patch to the HTTP/2 request (#1) message to create an HTTP/2 message (#2), and forwards the HTTP/2 request message (#2) to an RI-B application (Apps) 965. The RI-B Apps 965 modifies the HTTP/2 request message (#2) based on its business logic to create HTTP/2 message (#3). RI-B Apps 965 forwards the modified HTTP2 message (#3) back to RI-B Proxy 960. The RI-B proxy 960 shall create an Operations JSON patch document to describe the differences between the HTTP/2 messages #2 and #3, into a regular JSON document (in other words, not a JSON patch). The RI-B 960 shall digitally sign the resulted JSON object, which creates the JSON patch, and protect it with JWS. In an example, the RI-B 960 may sign the JSON object using the procedures described in 3GPP TS 33.501, section 13.2.4.5.2.

In a seventh step, the RI-B 960 shall send, to a pSEPP 980 over TLS, the JWE token generated by the cSEPP 920, and the JWS tokens generated by the RI-A 940 and itself. The JWE token and JWS tokens may be sent in an HTTPS message.

In an eighth step, the pSEPP 980 shall validate the JWE and JWS tokens and check the modifications against its security policy. If all validations succeed, the pSEPP 980 shall recreate the HTTP/2 request message from the JWE. In an example, the recreation may use the procedure as specified in 3GPP TS 33.501, section 13.2.4.7. Further, the pSEPP 980 shall apply the JSON patches that are generated by the RI-A 940 and RI-B 960 proxies. This results in a modified HTTP/2 request message.

In a ninth step, the pSEPP 980 shall send the modified HTTP/2 request message to a pNF 990.

In a tenth step, an HTTP/2 response message from the pSEPP 980 to the cSEPP 920 via the RI-B 960 and the RI-A 940 shall be protected and modified in the same way as the HTTP/2 request message, similar to the first step through ninth step above.

For example, the pNF 990 sends an HTTP/2 response to the pSEPP 980. Then, the pSEPP 980 shall reformulate and protect the HTTP/2 response message with JWE. The protection may be as specified in 3GPP TS 33.501, section 13.2.4.3. Accordingly, the pSEPP 980 creates a JWE token. Further, the pSEPP 980 shall send the JWE token, in an HTTPS message, to an RI-B Proxy 960 over TLS.

In addition, the RI-B Proxy 960 reconstructs the HTTP/2 response from the JWE token, forwards the HTTP/2 response (#1) to an RI-B application (Apps) 965, which modifies the response based on its business logic to create the HTTP/2 message (#2). The RI-B application 965 forwards the modified HTTP/2 message (#2) back to RI-B Proxy 960. The RI-B proxy 960 shall create an Operations JSON patch document to describe the differences between the original HTTP/2 message (#1) and the modified message (#2) in a regular JSON document (in other words, not a JSON patch). The RI-B 960 shall digitally sign the resulted JSON object, which creates the JSON patch and protect it with JWS. In an example, the RI-B 960 may sign the JSON object using the procedures described in 3GPP TS 33.501, section 13.2.4.5.2.

Also, the RI-B 960 shall send, to the RI-A 940 over TLS, the JWE token generated by the pSEPP 980, and the JWS token generated by itself. The JWE token and JWS token may be sent in an HTTPS message.

Additionally, the RI-A Proxy 940 reconstructs the HTTP/2 response (#1) from the JWE token, verifies the JWS token, applies the patch to the HTTP/2 response message (#1) to create an HTTP/2 response message (#2), and forwards the HTTP/2 response message (#2) to an RI-A application (Apps) 945. The RI-A Apps 945 modifies the HTTP/2 response message (#2) based on its business logic to create HTTP/2 response message (#3). RI-A Apps 945 forwards the modified HTTP2 message (#3) back to RI-A Proxy 940. The RI-B proxy 940 shall create an Operations JSON patch document to describe the differences between the HTTP/2 messages #2 and #3, into a regular JSON document (in other words, not a JSON patch). The RI-A 940 shall digitally sign the resulted JSON object, which creates the JSON patch, and protect it with JWS. In an example, the RI-A 940 may sign the JSON object using the procedures described in 3GPP TS 33.501, section 13.2.4.5.2.

Further, the RI-A Proxy 940 sends to a cSEPP 920 over TLS, the JWE token generated by the pSEPP 980, and the JWS tokens generated by the RI-B 960 and itself. The JWE token and JWS tokens may be sent in an HTTPS message.

In addition, the cSEPP 920 will validate the JWE and JWS tokens and check the modifications against its security policy. In addition, the pSEPP 980 may ensure that RI-A 940 and RI-B 960 on the N32-f connection are the same as those in N32-c connection. If all validations succeed, the pSEPP 980 shall recreate the HTTP/2 response message from the JWE. In an example, the recreation may use the procedure as specified in 3GPP TS 33.501, section 13.2.4.7. Further, the cSEPP 920 shall apply the JSON patches that are generated by the RI-A 940 and RI-B 960 proxies. This results in a modified HTTP/2 response message.

Moreover, the cSEPP 920 shall send the modified HTTP/2 response message to the cNF 910. In this example way, the HTTP/2 response message is sent from the pSEPP 980 to the cSEPP 920 via the RI-B 960 and the RI-A 940.

In an example, a first network node receives a first HTTPS request, including a first JWE token. The first network node may operate in a system, in an example. Further, the first network node reconstructs a first HTTP request based on the JWE token. Then, the first network node forwards the first HTTP request to a first RI application. Also, the first network node receives a second HTTP request from the first RI application. Additionally, the first network node creates a first JSON patch based on the first HTTP request and the second HTTP request. Further, the first RI Proxy protects the first JSON patch with JWS to create a first JWS token. Moreover, the first network node sends a second HTTPS request, including the first JWE token and the first JWS token.

The second HTTPS request is received by second network node. In an example, the second network node then reconstructs a third HTTP request based on the first JWE token. Further, the second network node validates the first JWS token. Also, the second network node creates a fourth HTTP request by applying first JSON patch in the JWS token to the third HTTP request. In addition, the second network node sends the fourth HTTP request to a second RI application. Then, the second network node receives a fifth HTTP request from the second RI application. Additionally, the second network node creates a second JSON patch based on the fourth HTTP request and the fifth HTTP request. Further, the second network node protects the second JSON patch with JWS to create a second JWS token. Moreover, the second network node sends a third HTTPS request, including the first JWE token, the first JWS token, and the second JWS token.

Additionally, or alternatively, the second network node receives a first HTTPS response, including a second JWE token. Further, the second network node reconstructs a first HTTP response based on the second JWE token. Also, the second network node forwards the first HTTP response to the second RI application. Additionally, the second network node receives a second HTTP response from the second RI application. Then, the second network node creates a third JSON patch based on the first HTTP response and the second HTTP response. In addition, the second network node protects the third JSON patch with a third JWS token. Moreover, the second network node sends a second HTTPS response, including the second JWE token, the third JSON patch and the third JWS token.

Additionally or alternatively, the first network node receives the second HTTPS response, including the second JWE token and the third JSON patch with the third JWS token. Further, the first network node reconstructs a third HTTP response based on the second JWE token. Also, the first network node validates the third JSON patch and the third JWS token. In addition, the first network node creates a fourth HTTP response by applying third JSON patch to the third HTTP response. Then, the first network node sends the fourth HTTP response to a second RI application. Additionally, the first network node receives a fifth HTTP response from the second RI application. Moreover, the first network node creates a fourth JSON patch based on the fourth HTTP response and the fifth HTTP response. The first network node protects the fourth JSON patch with a fourth JWS token. The first network node then sends a third HTTPS response, including the second JWE token, the third JSON patch, the third JWS token, the fourth JSON patch, and the fourth JWS token.

Additionally or alternatively, the second HTTP request is a modification of the first HTTP request, the fifth HTTP request is a modification of the fourth HTTP request, the second HTTP response is a modification of the first HTTP response, and the fifth HTTP response is a modification of the fourth HTTP response. Additionally or alternatively, wherein the first HTTP request, the second HTTP request, the third HTTP request, the fourth HTTP request, and the fifth HTTP request are HTTP/2 requests. Additionally or alternatively, the first HTTP response, the second HTTP response, the third HTTP response, the fourth HTTP response, and the fifth HTTP response are HTTP/2 responses.

Additionally or alternatively, the first HTTP request, the second HTTP request, the third HTTP request, the fourth HTTP request, and the fifth HTTP request are HTTP/3 requests. Additionally or alternatively, the first HTTP response, the second HTTP response, the third HTTP response, the fourth HTTP response, and the fifth HTTP response are HTTP/3 responses.

Additionally or alternatively, the first HTTPS request is received from a cSEPP, the third HTTPS request is sent to a pSEPP, the first HTTPS request is a reformulated request originating from a cNF, and the first HTTPS response is a reformulated response originating from a pNF. Additionally or alternatively, the first HTTPS request is received from visiting PLMN SEPP (vSEPP), and the third HTTPS request is sent to a home public land mobile network (PLMN) SEPP (hSEPP).

In an example, the first network node is or includes a first RI Proxy. Additionally or alternatively, the second network node is or includes a second RI Proxy.

Additionally or alternatively, one or more of the network nodes are or include an NF. In another example, one or more of the network nodes are or include an AMF. Additionally or alternatively, one or more of the network nodes are or include an SMF.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

What is claimed:

1. A method for use in a system, including a first network node, the method comprising:
in a first network node:
receiving a first hypertext transfer protocol secure (HTTPS) request, including a first JavaScript Object Notation (JSON) Web Encryption (JWE) token;
reconstructing a first hypertext transfer protocol (HTTP) request based on the JWE token;
forwarding the first HTTP request to a first roaming intermediary (RI) application;
receiving a second HTTP request from the first RI application;
creating a first JSON patch based on the first HTTP request and the second HTTP request;
protecting the first JSON patch with JSON Web Signature (JWS) to create a first JWS token; and
sending a second HTTPS request, including the first JWE token and the first JWS token.

2. The method of claim 1, wherein the system includes a second network node, and further comprising:
in the second network node:
receiving the second HTTPS request, including the first JWE token and the first JWS token;
reconstructing a third HTTP request based on the first JWE token;
validating the first JWS token;
creating a fourth HTTP request by applying first JSON patch in the JWS token to the third HTTP request;
sending the fourth HTTP request to a second RI application;
receiving a fifth HTTP request from the second RI application;
creating a second JSON patch based on the fourth HTTP request and the fifth HTTP request;
protecting the second JSON patch with JWS to create a second JWS token; and
sending a third HTTPS request, including the first JWE token, the first JWS token, and the second JWS token.

3. The method of claim 2, further comprising:
in the second network node:
receiving a first HTTPS response, including a second JWE token;
reconstructing a first HTTP response based on the second JWE token;
forwarding the first HTTP response to the second RI application;
receiving a second HTTP response from the second RI application;
creating a third JSON patch based on the first HTTP response and the second HTTP response;
protecting the third JSON patch with a third JWS token; and
sending a second HTTPS response, including the second JWE token, the third JSON patch and the third JWS token.

4. The method of claim 3, further comprising:
in the first network node:
receiving the second HTTPS response, including the second JWE token and the third JSON patch with the third JWS token;
reconstructing a third HTTP response based on the second JWE token;
validating the third JSON patch and the third JWS token;
creating a fourth HTTP response by applying third JSON patch to the third HTTP response;
sending the fourth HTTP response to a second RI application;
receiving a fifth HTTP response from the second RI application;
creating a fourth JSON patch based on the fourth HTTP response and the fifth HTTP response;
protecting the fourth JSON patch with a fourth JWS token; and
sending a third HTTPS response, including the second JWE token, the third JSON patch, the third JWS token, the fourth JSON patch, and the fourth JWS token.

5. The method of claim 4, wherein the second HTTP request is a modification of the first HTTP request, the fifth HTTP request is a modification of the fourth HTTP request, the second HTTP response is a modification of the first HTTP response, and the fifth HTTP response is a modification of the fourth HTTP response.

6. The method of claim 4, wherein the first HTTP request, the second HTTP request, the third HTTP request, the fourth HTTP request, and the fifth HTTP request are HTTP/2 requests; and wherein the first HTTP response, the second HTTP response, the third HTTP response, the fourth HTTP response, and the fifth HTTP response are HTTP/2 responses.

7. The method of claim 4, wherein the first HTTP request, the second HTTP request, the third HTTP request, the fourth HTTP request, and the fifth HTTP request are HTTP/3 requests; and wherein the first HTTP response, the second HTTP response, the third HTTP response, the fourth HTTP response, and the fifth HTTP response are HTTP/3 responses.

8. The method of claim 3, wherein the first network node is a first RI Proxy, the second network node is a second RI Proxy, the first HTTPS request is received from a consumer's Security Edge Protection Proxy (SEPP) (cSEPP), the third HTTPS request is sent to a producer's SEPP (pSEPP), the first HTTPS request is a reformulated request originating from a consumer's network function (cNF), and the first HTTPS response is a reformulated response originating from a producer's network function (pNF).

9. The method of claim 2, wherein the first HTTPS request is received from visiting PLMN SEPP (vSEPP), and the third HTTPS request is sent to a home public land mobile network (PLMN) SEPP (hSEPP).

10. A system comprising:
a first network node comprising:
a first processor; and
a first communications interface operatively coupled to the first processor; wherein:
the first processor and the first communications interface are configured to receive a first hypertext transfer protocol secure (HTTPS) request, including a first JavaScript Object Notation (JSON) Web Encryption (JWE) token;
the first processor is configured to reconstruct a first hypertext transfer protocol (HTTP) request based on the JWE token;
the first processor and the first communications interface are configured to forward the first HTTP request to a first roaming intermediary (RI) application;
the first processor and the first communications interface are configured to receive a second HTTP request from the first RI application;
the first processor is configured to create a first JSON patch based on the first HTTP request and the second HTTP request;
the first processor is configured to protect the first JSON patch with JSON Web Signature (JWS) to create a first JWS token; and
the first processor and the first communications interface are configured to send a second HTTPS request, including the first JWE token and the first JWS token.

11. The system of claim 10, wherein the system further comprises a second network node, the second network node comprising:
a second processor; and
a second communications interface operatively coupled to the processor; wherein:
the second processor and the second communications interface are configured to receive the second HTTPS request, including the first JWE token and the first JWS token;
the second processor is configured to reconstruct a third HTTP request based on the first JWE token;
the second processor is configured to validate the first JWS token;
the second processor is configured to create a fourth HTTP request by applying first JSON patch in the JWS token to the third HTTP request;
the second processor and the second communications interface are configured to send the fourth HTTP request to a second RI application;
the second processor and the second communications interface are configured to receive a fifth HTTP request from the second RI application;
the second processor is configured to create a second JSON patch based on the fourth HTTP request and the fifth HTTP request;
the second processor is configured to protect the second JSON patch with JWS to create a second JWS token; and
the second processor and the second communications interface are configured to send a third HTTPS request, including the first JWE token, the first JWS token, and the second JWS token.

12. The system of claim 11, wherein:
the second processor and the second communications interface are further configured to receive a first HTTPS response, including a second JWE token;
the second processor is further configured to reconstruct a first HTTP response based on the second JWE token;
the second processor and the second communications interface are further configured to forward the first HTTP response to the second RI application;
the second processor and the second communications interface are further configured to receive a second HTTP response from the second RI application;
the second processor is further configured to create a third JSON patch based on the first HTTP response and the second HTTP response;
the second processor is further configured to protect the third JSON patch with a third JWS token; and
the second processor and the second communications interface are further configured to send a second HTTPS response, including the second JWE token, the third JSON patch and the third JWS token.

13. The system of claim 12, wherein:
the first processor and the first communications interface are further configured to receive the second HTTPS response, including the second JWE token and the third JSON patch with the third JWS token;
the first processor is further configured to reconstruct a third HTTP response based on the second JWE token;
the first processor is further configured to validate the third JSON patch and the third JWS token;
the first processor is further configured to create a fourth HTTP response by applying third JSON patch to the third HTTP response;
the first processor and the first communications interface are further configured to send the fourth HTTP response to a second RI application;
the first processor and the first communications interface are further configured to receive a fifth HTTP response from the second RI application;
the first processor is further configured to create a fourth JSON patch based on the fourth HTTP response and the fifth HTTP response;
the first processor is further configured to protect the fourth JSON patch with a fourth JWS token; and
the first processor and the first communications interface are further configured to send a third HTTPS response, including the second JWE token, the third JSON patch, the third JWS token, the fourth JSON patch, and the fourth JWS token.

14. The system of claim 13, wherein the second HTTP request is a modification of the first HTTP request, the fifth HTTP request is a modification of the fourth HTTP request, the second HTTP response is a modification of the first HTTP response, and the fifth HTTP response is a modification of the fourth HTTP response.

15. The system of claim 13, wherein the first HTTP request, the second HTTP request, the third HTTP request, the fourth HTTP request, and the fifth HTTP request are HTTP/2 requests; and wherein the first HTTP response, the second HTTP response, the third HTTP response, the fourth HTTP response, and the fifth HTTP response are HTTP/2 responses.

16. The system of claim 13, wherein the first HTTP request, the second HTTP request, the third HTTP request, the fourth HTTP request, and the fifth HTTP request are HTTP/3 requests; and wherein the first HTTP response, the second HTTP response, the third HTTP response, the fourth HTTP response, and the fifth HTTP response are HTTP/3 responses.

17. The system of claim 12, wherein the first network node is a first RI Proxy, the second network node is a second RI Proxy, the first HTTPS request is received from a consumer's Security Edge Protection Proxy (SEPP) (cSEPP), the third HTTPS request is sent to a producer's SEPP (pSEPP), the first HTTPS request is a reformulated request originating from a consumer's network function (cNF), and the first HTTPS response is a reformulated response originating from a producer's network function (pNF).

18. The system of claim 11, wherein the first HTTPS request is received from visiting PLMN SEPP (vSEPP), and the third HTTPS request is sent to a home public land mobile network (PLMN) SEPP (hSEPP).

19. A system comprising:
a first network node comprising:
a processor; and
a communications interface operatively coupled to the processor; wherein:
the processor is configured to generate a JavaScript Object Notation (JSON) Web token (JWT) based on connection purpose information, an originating network identity (ID), a fully qualified domain name (FQDN) of the first network node, intended purpose information, a request uniform resource identifier (URI), a timestamp, and an expiration time;
the processor is configured to digitally sign the JWT to create a JSON Web Signature (JWS) token using a digital signature algorithm and a private key;
the processor is configured to digitally sign a hypertext transfer protocol (HTTP) CONNECT request message by appending the JWS token, wherein the JWS token includes one or more of the connection purpose information, the originating network ID, the FQDN of the first network node, the intended purpose information, the request URI, the timestamp, the expiration time, a digital signature used in the digital signature algorithm, a public key certificate associated with the private key used to create the digital signature, and a certificate chain; and
the transceiver and the transceiver are configured to send the digitally signed HTTP CONNECT request message, including HTTP CONNECT request header information and the JWS token.

20. The system of claim 19, wherein the system further comprises a second network node, the second network node comprising:
a second processor; and
a second communications interface operatively coupled to the processor; wherein:
the second processor and the second communications interface are configured to receive the digitally signed HTTP CONNECT request message, including HTTP CONNECT request header information and the JWS token; and
the second processor is configured to verify the digital signature of the digitally signed HTTP CONNECT request message based on a determination that the public key certificate associated with the digital signature is trusted, and based on a determination that the FQDN of the first network node, carried in the HTTP CONNECT request message, matches an FQDN in a SubjectAltName (SAN) field in the public key certificate; and
the second processor and the second communications interface are configured to, based on the verification of the digital signature, allow an N32-c connection establishment and establish a transmission control protocol (TCP) connection towards a third network node.
